(19) United States
(12) Patent Application Publication
(10) Pub. No.: US 2013/0020824 A1
(43) Pub. Date: Jan. 24, 2013

(54) Partitioning a Vehicle Interior

(71) Applicant: Chaya Tinterow, Houston, TX (US)

(72) Inventor: Chaya Tinterow, Houston, TX (US)

(21) Appl. No.: 13/185,626

(22) Filed: Jul. 19, 2011

(51) Int. Cl. B60N 3/00; B23P 11/00

(52) U.S. Cl. 296/24.46; 29/428; 296/24.4

(57) ABSTRACT

A first planar partition member is positioned behind a seat in a vehicle. A second planar partition member is moved into a position relative to the first planar partition member such that the first and second planar partition members block air from flowing above the seat.

### BACKGROUND

Today's motor vehicles, which include automobiles, trucks, sports utility vehicles, minivans, cargo vans, buses, and other similar vehicles, are often equipped with heaters and/or air conditioners intended to keep the occupants of the motor vehicles comfortable even when the weather outside the vehicle is inclement. At the same time, such vehicles often have multiple rows of seats, i.e., a “front” seat and one or more sets of “back” seats. For example, most automobiles have one set of back seats. Some vehicles, particularly sports utility vehicles and minvans, have additional rows of seats or storage areas behind the first back seat.

In some cases, however, only the front seat, and often only the driver's seat, of a vehicle is occupied when it is being operated. Establishing and maintaining a comfortable temperature for the occupants of a vehicle in such a circumstance can be challenging.

### SUMMARY

In one aspect, the invention features a method. The method includes positioning a first planar partition member behind a seat in a vehicle. The method includes moving a second planar partition member into a position relative to the first planar partition member such that the first and second planar partition members block air from flowing above the seat.

Implementations of the invention may include one or more of the following. The method may include attaching the second planar partition member to an attachment point within the vehicle such that the second planar partition member remains substantially in the position. The second planar partition member may be hingably attached to the first planar partition member. Moving the second planar partition member may include rotating the second planar partition member relative to the first planar partition member. Rotating includes unfolding the second partition member with respect to the first partition member.

In another aspect, the invention features an apparatus. The apparatus includes a first planar partition member having two dimensions substantially the same as dimensions of a portion of a plane through a vehicle that is behind a front seat of the vehicle, inside the vehicle, and below a hinge line. The apparatus includes a second planar partition member having two dimensions substantially the same as dimensions of a portion of the plane through the vehicle that is behind the front seat of the vehicle, inside the vehicle, and above the hinge line. The apparatus includes a hinge at the hinge line coupling the first planar partition member to the second planar partition member.

Implementations of the invention may include one or more of the following. The apparatus may include a window in the second planar partition member. The apparatus may include a first seal band along an edge of the first planar partition member. The apparatus may include a second seal band along an edge of the second planar partition member. The apparatus may include a strap for attaching the second planar partition member to a fixed point on the vehicle. The hinge may be selected from a group consisting of tape and a piano hinge.

In another aspect, the invention features a method. The method comprises inserting a first planar partition member having two dimensions substantially the same as dimensions of a portion of a plane through a vehicle that is behind a front seat of the vehicle, inside the vehicle, and below a hinge line. The method further includes moving a second planar partition member with respect to a hinge at the hinge line coupling the first planar partition member to the second planar partition member, the second planar partition member having two dimensions substantially the same as dimensions of a portion of the plane through the vehicle that is behind the front seat of the vehicle, inside the vehicle, and above the hinge line.

### BRIEF DESCRIPTION OF THE DRAWINGS

FIG. 1 illustrates the flow of air across a front seat in a vehicle.

FIGS. 2 and 3 show the installation of a partition in a vehicle.

FIG. 4 illustrates the flow of air in a vehicle with the partition installed.

FIG. 5 illustrates the partition.

FIGS. 6-8 illustrate an attaching device for attaching the partition to a vehicle.

### DETAILED DESCRIPTION

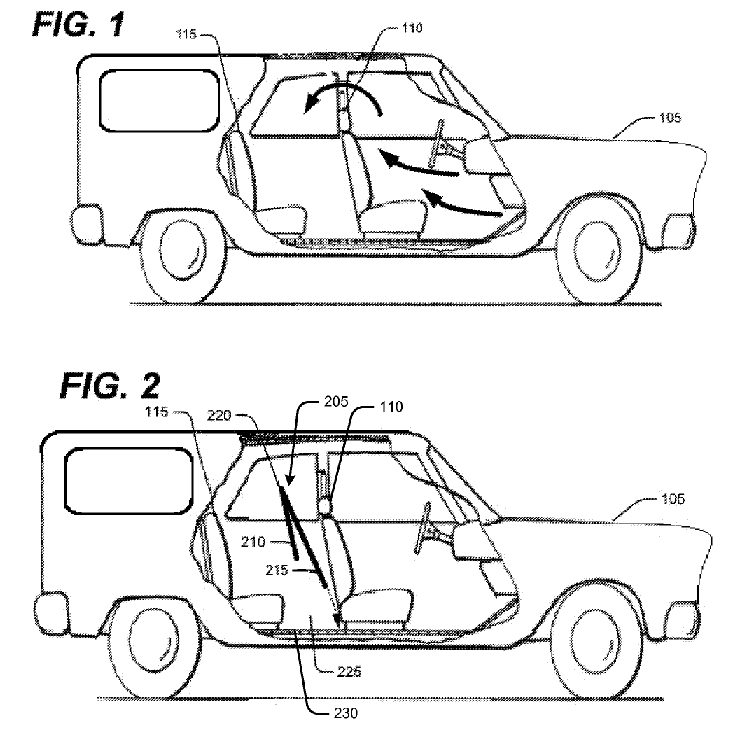

Some air (indicated by the arrows) from a heater or an air conditioner in a vehicle 105, as shown in FIG. 1, flows across the top of a front seat 110 and toward the back seat 115. The energy used to heat or cool such air is wasted in some situations, such as, for example, when there is no person or object in the back seat. While FIG. 1 shows a sports utility vehicle, it will be understood that the apparatus and method described herein is useful in any vehicle, including small sports cars, sedans, minivans, trucks, buses, military vehicles, etc.

In one embodiment, a partition 205, illustrated in FIG. 2, which includes an upper planar partition member 210 and a lower planar partition member 215 connected by a hinge 220, is positioned in a well 225 behind the front seat 110 of the vehicle 105. In one embodiment, the lower planar partition member 215 is against the floorboard 230. In one embodiment, the lower planar partition member 215 is suspended above the floorboard 230. The positioning motion is indicated by the dashed arrow in FIG. 2. In one embodiment, when it is positioned, the lower planar partition member 215 is substantially perpendicular to the floorboard 230. In one embodiment, in this context, substantially perpendicular is defined to mean within 10 degrees. In one embodiment, in this context, substantially perpendicular is defined to mean within 20 degrees. In one embodiment, in this context, substantially perpendicular is defined to mean within 30 degrees. In one embodiment, when it is positioned, the lower planar partition member 215 is at an angle to the floorboard 230 that is greater than 30 degrees but less than 60 degrees.

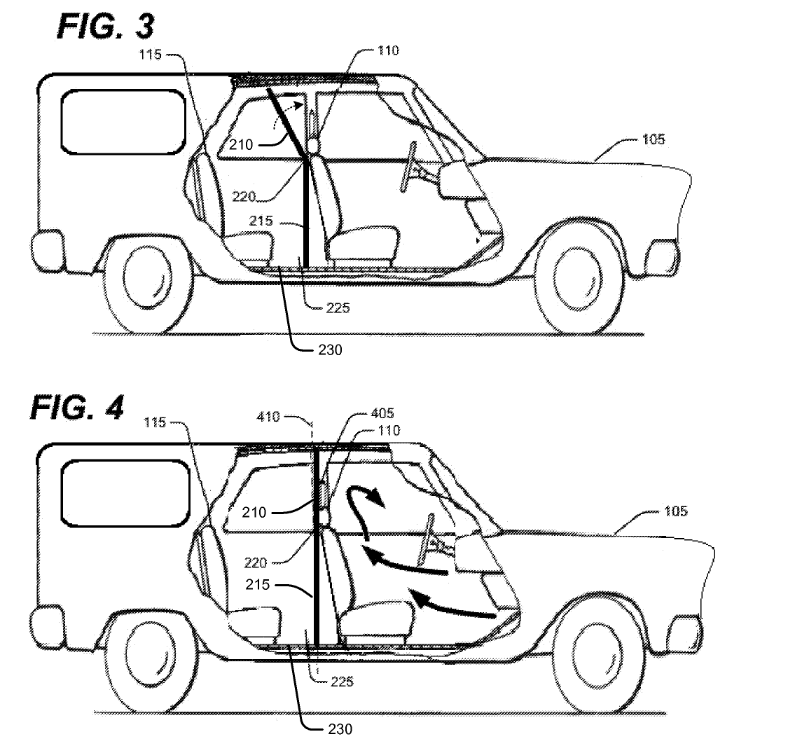

Then, in one embodiment, as shown by the dashed arrow in FIG. 3, the upper planar partition member 210 is rotated about the hinge 220 until it blocks the flow of air in the space above the front seat 110. In one embodiment, a strap 405 from the upper planar partition member 210 is then attached, as shown in FIG. 4, to a connection point on the vehicle 105 to keep the partition 205 in place.

In one embodiment, the partition 205 includes more than two partition members that fold with respect to each other. For example, in one embodiment, the partition 205 includes an upper planar partition member, a center planar partition member, and a lower planar partition member. In another embodiment, the partition includes more than three planar partition members.

In one embodiment, the joints between the planar partition members are not hinges but are instead sliding joints, such that the planar partition members slide with respect to each other.

In one embodiment, the upper planar partition member 210 has two dimensions substantially the same as dimensions of a portion of a plane 410 through the vehicle 105 that is behind the front seat of the motor vehicle, inside the motor vehicle, and above a hinge line. In one embodiment, the lower planar partition member 215 has two dimensions substantially the same as dimensions of a portion of the plane 410 through the motor vehicle that is behind the front seat of the motor vehicle, inside the motor vehicle, and below the hinge line.

In one embodiment, one of the dimensions, a first dimension, is measured along a line parallel to the plane of the drawing in FIG. 4 and along the dashed line in FIG. 4 that represents the plane 410. In one embodiment, one of the dimensions, a second dimension, is measured along a line that is perpendicular to the dashed line in FIG. 4 that represents the plane 410 and into the page holding FIG. 4.

In one embodiment, the hinge line is in the plane 410, parallel to the second dimension, and within 10 percent of a minimum distance from the hinge 220.

In one embodiment, in this context, “substantially the same” means within 10 percent. In one embodiment, “substantially the same” means within 5 percent. In one embodiment, “substantially the same” means within 1 percent. In one embodiment, the plane 410 is within 5 degrees of vertical. In one embodiment, the plane 410 is within 10 degrees of vertical. In one embodiment, the plane 410 is within 30 degrees of vertical.

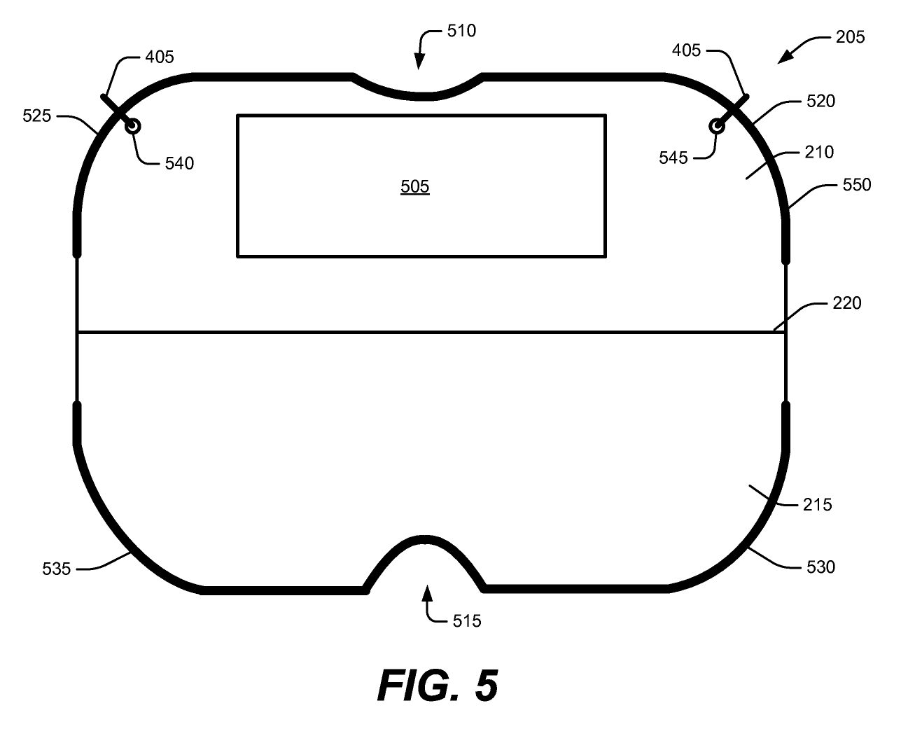

In one embodiment, illustrated in FIG. 5, the upper planar partition member 210 is formed of a stiff lightweight insulating material. For example, in one embodiment, a 4′×8′×½″ sheet of R-MATTE®, manufactured by RMAX, Inc., is cut to the proper dimensions, i.e., in one case 44″×56″×½″, to create the upper planar partition member 210.

In one embodiment, the lower planar partition member 215 is formed of a stiff lightweight insulating material. For example, in one embodiment, a 4′×8′×½″ sheet of R-MATTE®, manufactured by RMAX, Inc., is cut to the proper dimensions, i.e., in one case 44″×56″×½″, to create the lower planar partition member 215.

In one embodiment, the upper planar partition member 210 includes a clear window 505, made of a thin, transparent, acrylic or plastic material, such as DURAPLEX® Extra Strength clear acrylic manufactured by Plaskolite, Inc. In one embodiment, the window 505 is 12″ high by 24″ wide. In one embodiment, the window 505 is located so that a driver will have a clear view through the rear view mirror (not shown) of the vehicle 105 when the partition 205 is in the position shown in FIG. 4.

In one embodiment, the upper planar partition member 210 includes a top curved cut-out 510 to accommodate a compartment, such as a roof console used for example to contain sunglasses, garage door openers, and other similar devices and instruments, that is sometimes present in a vehicle. The top curved cut-out 510 is optional and is not present in some embodiments.

In one embodiment, the lower planar partition member 215 includes a bottom curved cut-out 515 to accommodate a transmission hump that is sometimes present in the well 225 of a vehicle. The bottom curved cut-out 515 is optional and is not present in some embodiments.

In one embodiment, the upper planar partition member 210 is curved at the upper outside edges 520, 525 to conform to the inner surface of the roof of the vehicle 105 behind the front seat 110.

In one embodiment, the lower planar partition member 215 is curved at the lower outside edges 530, 535 to avoid contact with the rear doors of the vehicle 105.

In one embodiment, the hinge 220 is a traditional hinge, such as a piano hinge. In one embodiment, the hinge 220 is formed using tape, such as duct tape, applied along the length of the line indicating the hinge 220 in FIG. 5.

In one embodiment, the straps 405 (only one is shown in FIG. 4 but both are shown in FIG. 5) pass through grommets 540, 545. In one embodiment, the straps 405 are self-fastening, such as strips of VELCRO®, manufactured by Velcro Industries. In one embodiment, the straps 405 form loops that can be opened and closed by fastening and unfastening, for example, the VELCRO fasteners.

In one embodiment, an insulation material 550, such as ½ inch tubular foam insulation that is used to insulate pipes, for example, is fastened along all edges of the partition 205. In one embodiment, the insulation material 550 forms a gasket between the partition 205 and the roof, rear doors, and rear floor of the vehicle 105. In one embodiment, shown in FIG. 5, gaps in the tubular insulation material 550 near the hinge 220 accommodate rear door armrests that are present in some vehicles.

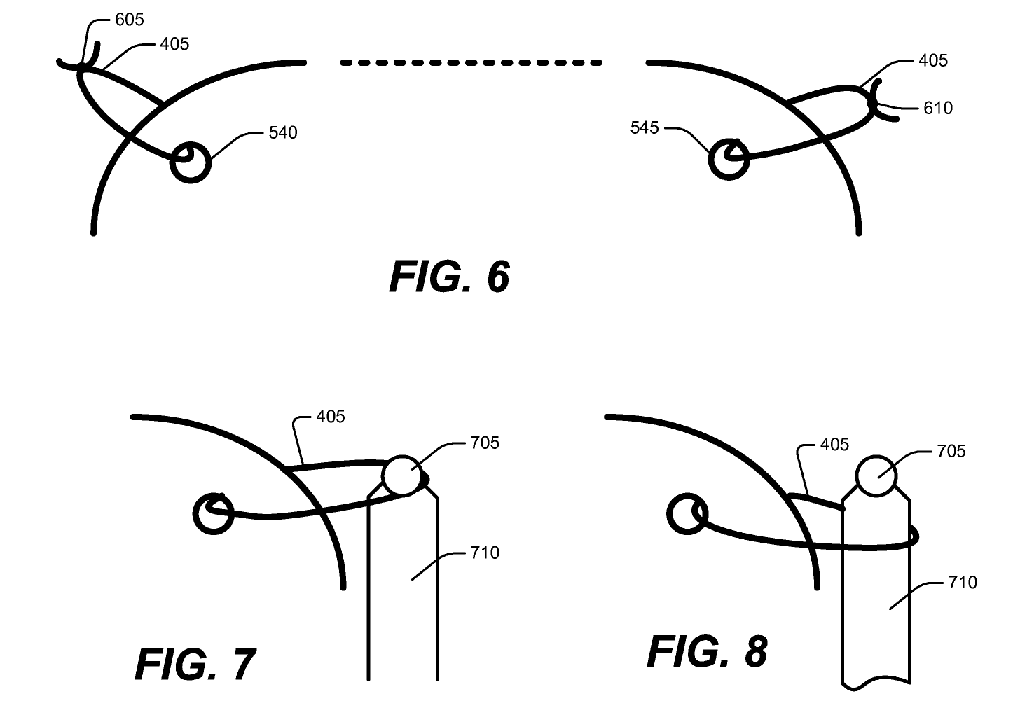

The straps 405 and grommets 540, 545 are shown in more detail in FIG. 6. While the straps 405 are shown as strings or ropes with knots 605, 610, it will be understood that the straps can be made of other materials, such as strips of VELCRO, as discussed above.

In one embodiment, shown in FIG. 7, the straps 405 attach to a fastener 705 used to attach a seat belt 710 to a wall of the vehicle 105. In one embodiment, shown in FIG. 8, the straps 405 wrap around the seat belt 710. In one embodiment, the straps 405 are attached to other convenient attachment points in the vehicle 105, such as a headrest, a headrest post, a clothing hook, or a strap, not shown.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method comprising:
positioning a first planar partition member behind a seat in a vehicle;
moving a second planar partition member into a position relative to the first planar partition member such that the first and second planar partition members block air from flowing above the seat.

2. The method of claim 1 further comprising:
attaching the second planar partition member to an attachment point within the vehicle such that the second planar partition member remains substantially in the position.

3. The method of claim 1 wherein:
the second planar partition member is hingably attached to the first planar partition member; and
moving the second planar partition member comprises rotating the second planar partition member relative to the first planar partition member.

4. The method of claim 3 wherein rotating comprises unfolding the second partition member with respect to the first partition member.

5. An apparatus comprising:
a first planar partition member having two dimensions substantially the same as dimensions of a portion of a plane through a vehicle that is behind a front seat of the vehicle, inside the vehicle, and below a hinge line;
a second planar partition member having two dimensions substantially the same as dimensions of a portion of the plane through the vehicle that is behind the front seat of the vehicle, inside the vehicle, and above the hinge line; and
a hinge at the hinge line coupling the first planar partition member to the second planar partition member.

6. The apparatus of claim 5 further comprising:
a window in the second planar partition member.

7. The apparatus of claim 5 further comprising:
a first seal band along an edge of the first planar partition member; and
a second seal band along an edge of the second planar partition member.

8. The apparatus of claim 5 further comprising:
a strap for attaching the second planar partition member to a fixed point on the vehicle.

9. The apparatus of claim 5 wherein the hinge is selected from a group consisting of tape and a piano hinge.

10. A method comprising:
inserting a first planar partition member having two dimensions substantially the same as dimensions of a portion of a plane through a vehicle that is behind a front seat of the vehicle, inside the vehicle, and below a hinge line;
moving a second planar partition member with respect to a hinge at the hinge line coupling the first planar partition member to the second planar partition member, the second planar partition member having two dimensions substantially the same as dimensions of a portion of the plane through the vehicle that is behind the front seat of the vehicle, inside the vehicle, and above the hinge line.

11. The method of claim 10 further comprising:
attaching the second planar partition member to an attachment point within the vehicle such that the second planar partition member remains substantially in a position.

12. The method of claim 10 wherein:
moving the second planar partition member comprises rotating the second planar partition member relative to the first planar partition member.

13. The method of claim 12 wherein rotating comprises unfolding the second partition member with respect to the first partition member.
